(19) United States
(12) Patent Application Publication
(10) Pub. No.: US 2023/0281442 A1
(43) Pub. Date: Sep. 7, 2023

(54) METHOD AND SYSTEM FOR SCHEDULING

(71) Applicant: KONINKLIJKE PHILIPS N.V., Eindhoven (NL)

(72) Inventors: Eltjo Hans HASELHOFF, EINDHOVEN (NL); Yan GLICKBERG, NORTH ROYALTON, OH (US)

(21) Appl. No.: 18/104,816

(22) Filed: Feb. 2, 2023

Related U.S. Application Data
(60) Provisional application No. 63/306,117, filed on Feb. 3, 2022.

(51) Int. Cl. G06N 3/08

(52) U.S. Cl. CPC G06N 3/08

(57) ABSTRACT

A computer-implemented method is configured for scheduling multiple pathways in a schedule, each pathway including a collection of related events. The computer-implemented method includes training, with processor, a neural network with a repository of historical rescheduling data to create a trained data set. The computer-implemented method further includes assigning, with the processor, resources from a resource pool to each of the events of each of the pathways to create the schedule. The computer-implemented method further includes detecting, with the processor, a change in a resource assigned to an event. The computer-implemented method further includes automatically adjusting, with the processor, at least one other event in the schedule in response to the detected change based on the trained data set to predict an optimal adjustment to the schedule with a prediction model.

### CROSS REFERENCE TO RELATED APPLICATIONS

This application claims the benefit of U.S. Provisional Pat. Application No. 63/306,117 filed Feb. 3, 2022. This application is hereby incorporated by reference herein.

### TECHNICAL FIELD

The following generally relates to scheduling multiple pathways on a schedule and more particularly to concurrently scheduling and/or rescheduling related events of each of the pathways semi-automatically or automatically utilizing cost functions and/or artificial intelligence.

### BACKGROUND

Scheduling software, such as the calendar in Microsoft® Outlook®, or dedicated schedulers for specific applications, typically handles a single event at the time. For example, in Outlook® one schedules a meeting, specifies participants, time and location. In practice, however, a scheduled event is not an independent, stand-alone occurrence. This is particularly the case in hospitals, where a clinical care path includes a collection of related events, which take place with different resources (e.g., patients, nurses, doctors, equipment, etc.) at different times and in locations (e.g., pre-procedure, procedure and post-procedure rooms), with dependencies.

For example, a cardiac intervention patient must first check in with the admitting clerk before being prepared for a procedure and be prepared in a preparation room before being taken to a cardiac catheterization lab, and, only after the procedure has been completed is the patient taken to a recovery room and then later finally discharged. With this example, a patient is scheduled to arrive at a particular time, scheduled for the preparation room with suitable personnel, scheduled for the cardiac catheterization lab with suitable personnel, and scheduled for the recovery room along with suitable personnel. This becomes even more tedious when several patients are scheduled on a same day for cardiac catheterization lab procedures where there are a finite number of time slots, procedure rooms and resources.

After a schedule is created, unexpected events can cause conflicts in such a schedule. For example, a patient arriving late or an emergency requiring immediate attention may push out, delay, or otherwise affect the timing of all subsequent scheduled procedures for a particular cardiac catheterization lab room, which may result in a scheduled event conflict where there is not enough personnel and/or equipment available to complete a related event of a delayed procedure(s) and/or a procedure(s) scheduled in another procedure room. Unfortunately, there are so many linked processes and resources with any given procedure that there would be an unreasonable number of permutations of possible rescheduling changes for staff to manually reschedule the day. Moreover, attempts to manually reschedule with so many permutations would be reckless and irresponsible, especially in a clinical setting. Accordingly, a human being cannot practically perform the act of manually rescheduling the day in the mind, with or without a physical aid such as pen and paper.

### SUMMARY

Aspects described herein address the above-referenced problems and/or others.

In one aspect, a computer-implemented method is configured for scheduling multiple pathways in a schedule, each pathway including a collection of related events. The computer-implemented method includes training, with processor, a neural network with a repository of historical rescheduling data to create a trained data set. The computer-implemented method further includes assigning, with the processor, resources from a resource pool to each of the events of each of the pathways to create the schedule. The computer-implemented method further includes detecting, with the processor, a change in a resource assigned to an event. The computer-implemented method further includes automatically adjusting, with the processor, at least one other event in the schedule in response to the detected change based on the trained data set to predict an optimal adjustment to the schedule with a prediction model.

In another aspect, a computing system is configured for scheduling multiple pathways in a schedule, each pathway including a collection of related events. The computing system comprises a memory and a processor. The memory includes an artificial intelligence module, a monitoring module and a scheduling module. The processor is configured to train, with the artificial intelligence module, a neural network with a repository of historical rescheduling data to create a trained data set. The processor is further configured to assign, with the scheduling module, resources from a resource pool to each of the events of each of the pathways to create the schedule. The processor is further configured to detect, with the monitoring module, a change in a resource assigned to an event. The processor is further configured to automatically adjust, with the scheduling module, at least one other event in the schedule in response to the detected change based on the trained data set to predict an optimal adjustment to the schedule with a prediction model.

In another aspect, a computer-readable storage medium stores instructions for scheduling multiple pathways in a schedule where each pathway includes a collection of related events. The instructions, when executed by a processor of a computer, cause the processor to: train a neural network with a repository of historical rescheduling data to create a trained data set, assign resources from a resource pool to each of the events of each of the pathways to create the schedule, detect a change in a resource assigned to an event, and automatically adjust at least one other event in the schedule in response to the detected change based on the trained data set to predict an optimal adjustment to the schedule with a prediction model.

Those skilled in the art will recognize still other aspects of the present application upon reading and understanding the attached description.

### BRIEF DESCRIPTION OF THE DRAWINGS

The invention may take form in various components and arrangements of components, and in various steps and arrangements of steps. The drawings are only for purposes of illustrating the embodiments and are not to be construed as limiting the invention.

FIG. 1 diagrammatically illustrates an example system for scheduling multiple pathways on a schedule, in accordance with an embodiment(s) herein.

FIG. 2 diagrammatically illustrates an example of a pathway of the scheduled multiple pathways, in accordance with an embodiment(s) herein.

FIG. 3 diagrammatically illustrates an example user interface for scheduling the multiple pathways on the schedule, in accordance with an embodiment(s) herein.

FIG. 4 diagrammatically illustrates the example user interface of FIG. 3 further presenting a quality score, in accordance with an embodiment(s) herein.

FIG. 5 diagrammatically illustrates the example user interface of FIG. 4 with a single pathway, including all related events, scheduled in a time slot in a location time window, in accordance with an embodiment(s) herein.

FIG. 6 diagrammatically illustrates the example user interface of FIG. 5 with the single pathway moved to another time slot in the location time window, in accordance with an embodiment(s) herein.

FIG. 7 diagrammatically illustrates the example user interface of FIG. 4 with multiple pathways, including all their related events, scheduled in time slots of a location time window across locations, in accordance with an embodiment(s) herein.

FIG. 8 diagrammatically illustrates the example user interface of FIG. 7 where a next scheduled pathway results in a resource conflict, in accordance with an embodiment(s) herein.

FIG. 9 diagrammatically illustrates the example user interface of FIG. 8 in which the system automatically resolves the resource conflict by rescheduling another pathway, in accordance with an embodiment(s) herein.

FIG. 10 diagrammatically illustrates the example user interface of FIG. 9 in which a delay in an event of one pathway results in a resource conflict in the schedule, in accordance with an embodiment(s) herein.

FIG. 11 diagrammatically illustrates the example user interface of FIG. 10 in which the system automatically resolves the resource conflict by pushing events in multiple other pathways, in accordance with an embodiment(s) herein.

FIG. 12 diagrammatically illustrates the example user interface of FIG. 10 in which the system automatically resolves the resource conflict by moving up events in another pathway, in accordance with an embodiment(s) herein.

FIG. 13 diagrammatically illustrates an example method, in accordance with an embodiment(s) herein.

FIG. 14 diagrammatically illustrates another example method, in accordance with an embodiment(s) herein.

FIG. 15 diagrammatically illustrates yet another example method, in accordance with an embodiment(s) herein.

FIG. 16 diagrammatically illustrates still another example method, in accordance with an embodiment(s) herein.

FIG. 17 diagrammatically illustrates another example method in accordance with an embodiment(s) herein.

### DESCRIPTION OF EMBODIMENTS

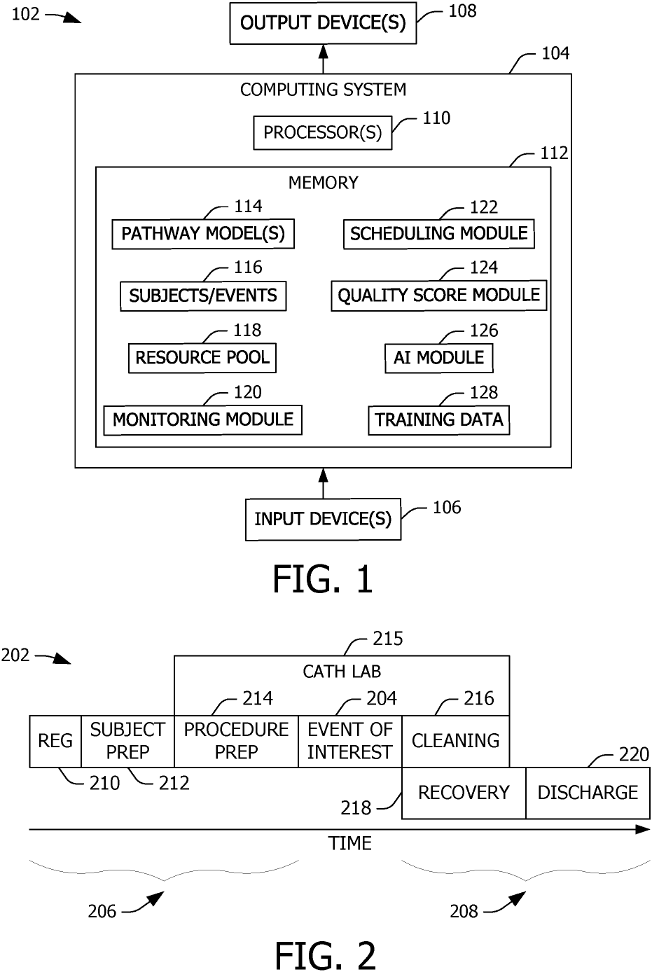

FIG. 1 diagrammatically illustrates an example system 102. The system 102 includes a computing system 104, such as a computer, a workstation, etc., along with an input device(s) 106, such as a keyboard, a mouse, a touchscreen, an input port, etc., and an output device(s) 108 such as a display monitor, an output port, etc. The computing system 104 further includes a processor 110 (e.g., a central processing unit (CPU), a microprocessor (mP), graphics processing unit (GPU), and/or other processor) and a memory (computer readable storage medium) 112, which excludes transitory medium and includes only non-transitory storage medium such as physical memory, a memory device, etc.

The processor 100 is configured for scheduling multiple pathways on a schedule and/or rescheduling one or more events of one or more of the scheduled pathways. In general, a pathway, as utilized herein, includes an event of interest to be scheduled along with a collection of all related events that need to be scheduled to take place prior to and after the event of interest. When scheduling multiple pathways, all of the events that need to be scheduled for each of the pathways are scheduled when scheduling each corresponding event of interest.

Briefly turning to FIG. 2, an example clinical care pathway 202 is illustrated. For explanatory purposes, the clinical care pathway 202 is described for a cardiac intervention event of interest 204 such as, but not limited to, a percutaneous transluminal coronary angioplasty (PTCA), a sudden cardiac death (SCD) risk assessment post a myocardial infarction (MI), etc. However, it is to be appreciated that another pathway(s) for another medical procedure(s) and/or a pathway(s) for an event of interest of a non-medical collection of related events are also contemplated herein.

The clinical care pathway 202 includes the cardiac intervention event of interest 204, pre-intervention events 206 and post-intervention events 208. In general, the pre-intervention events 206 occur before the cardiac intervention event of interest 204 and the post-intervention events 208 occur after the cardiac intervention event of interest 204. The events occur sequentially in time, e.g., where an event is dependent on completion of a prior event, etc., and/or concurrently in time, e.g., where different events occur at different locations concurrently in time and the different events are independent of each other, etc.

The pre-intervention events 206 include a subject registration event (“REG”) 210 that requires a subject and an admitting (human and/or computer) clerk. The pre-intervention events 206 further include a subject preparation event (“SUBJECT PREP”) 212 that requires the subject, subject preparation staff (e.g., a nurse(s), etc.), and a subject preparation room. The pre-intervention events 206 further include a procedure preparation event (“PROCEDURE PREP”) 214 that requires the subject, procedure preparation staff (e.g., a nurse(s), a technologist(s), etc.), and an examination room / cardiac catheterization lab (“CATH LAB”) 215.

The event of interest 204 requires the subject, intervention staff (e.g., a doctor(s), a nurse(s), etc.), and the examination room / cardiac catheterization lab 215. The illustrated post-intervention events 208 include an examination room cleanup event (“CLEANING”) 216 that requires cleaning staff and the examination room / cardiac catheterization lab 215. The post-intervention events 208 further include a recovery event (“RECOVERY”) 218 that requires the subject and recovery staff (e.g., a nurse(s), etc.) and a recovery room. The post-intervention events 208 further include a subject discharge event (“DISCHARGE”) 220 that requires the subject, discharge staff (e.g., a doctor(s), a nurse(s), etc.) and the recovery room.

In this example, the events occur left to right in time, with the examination room cleanup event 216 of the examination room / cardiac catheterization lab 215 and the recovery event 218 in the recovery room overlapping partially in time. In addition, the procedure preparation event 214, the cardiac intervention event of interest 204 and the examination room cleanup event 216 all require the same room, the examination room / cardiac catheterization lab 215. This means that when scheduling the cardiac intervention event of interest 204 for multiple pathways, each cardiac intervention event of interest 204 cannot be scheduled in an examination room prior to completion of the examination room cleanup event 216 of the examination room of a prior scheduled cardiac intervention event of interest 204 and completion of the procedure preparation event 214 in the examination room for the subject being scheduled.

Returning to FIG. 1, the memory 112 includes at least one pathway model (pathway model(s)) 114. In this example, the at least one pathway model 114 represents a pathway (e.g., the clinical care pathway 202 of FIG. 2) and includes at least the events of the pathway (e.g., events 210, 212, 214, 204, 216, 218 and 220 in FIG. 2), an estimated amount of time of each event, a type of staff required for each event, a required number of each type of staff for each event, and a type of equipment required for each event (e.g., a C-arm scanner, a non-invasive blood pressure (NIBP) monitor, etc. for the cardiac intervention event 204 of the clinical care pathway 202 in FIG. 2).

The at least one pathway model 114 can be predefined and loaded in the memory 112. Alternatively, or additionally, the at least one pathway model 114 (or another pathway model) can be created and/or modified using the system 102, e.g., a pathway creator or editor. Alternatively, or additionally, the at least one pathway model 114 (or another pathway model) can be stored remote from the memory 112, e.g., in memory of a different computing system, in portable memory, in one or more servers, cloud based data storage, etc. With remote storage, the at least one pathway model 114 (or another pathway model) can be loaded to the memory 112 and/or remotely accessed.

The memory 112 further includes a subject/event list (“subjects/events”) 116. The subject/event list 116 is a list of all subjects to be scheduled for events of interest on a same day, e.g., the next day, etc., and the event of interest of each subject to be scheduled. For example, an entry in the list may indicate that John Doe is to be scheduled for a PTCA tomorrow. Each entry of the subject/event list 116 is entered/populated manually by a user, e.g., via a keyboard of the input device(s) 106, and/or the subject/event list 116 is provided to the computing system 102 over a network, via portable memory, etc., of the input device(s) 106.

The memory 112 further includes a resource pool 118. The resource pool 118 includes the staff relevant to the events to be scheduled that particular day with staff member hours of availability for that particular day, locations (e.g., examination rooms, etc.) relevant to the events to be scheduled that particular day and times of availability of the locations that particular day, a list of equipment relevant to the events to be scheduled that particular day, and times of availability of the equipment that particular day. The resource pool 118 is manually entered, e.g., via a keyboard of the input device(s) 106, and/or provided to the computing system 102 over a network, via portable memory, etc., of the input device(s) 106.

The memory 112 further includes a monitoring module 120. The monitoring module 120 is configured to communicate with technology that can track workflow, either automatically or by manual input from users. Automated workflow tracking can be achieved through, e.g., camera sensors linked to a neural network for automatically recognizing and tracking the roles and activities of individuals. That is, cameras can be used to capture images/video of staff members, and, through automated software facial detection, identify and track a patient or staff members, their roles (e.g., patient versus clinician) and their activities (e.g., patient sitting in a waiting room, patient entering or exiting an examination room, clinician entering or exiting an examination room, etc.).

Additionally, or alternatively, cameras can be used to capture images/video of equipment (e.g., an imaging system such as an angiography X-ray system, an electrocardiograph, an apparatus used for moving patients such as a gurney or a wheelchair, etc.) utilized for implementing an event (e.g., of a clinical pathway), and, through automated software detection, identify and track operation of the equipment. This may include, e.g., detecting a patient is sitting or lying down (or is no longer sitting or lying down) on a patient support of the imaging system, the gurney or the wheelchair, detecting use of an input device (e.g., a keyboard, a mouse, a touch screen, a microphone, etc.) of a computer controlling the imaging system, detecting a display of an image on a display monitor of the imaging system, detecting cable lead wires of the electrocardiograph are attached or being attached to electrodes on a patient, detecting an electrocardiogram waveform is being displayed on a display monitor of the electrocardiograph, etc.

Automated workflow tracking can also be achieved through e.g., triggers from a computer system(s) or from medical equipment (e.g., Imaging Systems, Hospital Information System, Radiology Information System etc.) so that progress of predetermined tasks can be tracked. For example, a checklist represented through an electronic form may include a list of events (e.g., patient registered, patient prepared for procedure, examination room prepared for the procedure, procedure completed, examination room cleaned, patient in recovery room, patient discharge, etc.) for a pathway (e.g., the pathway 202). In one instance, the electronic form includes at least one checkbox for each event in the list. Each checkbox initially is unchecked to indicate the corresponding event has not started and/or is not completed. A user of the computer system or medical equipment employs an input device (e.g., a keyboard, a mouse, a touch screen, a microphone, etc.) of the computer system or medical equipment to toggle a state of a checkbox for an event from unchecked to checked to indicate the state of the event has changed, e.g., the event has been completed.

In response to a checkbox being toggled as such, the computer system or medical equipment transmits a signal that indicates the change in the state and the corresponding event, and the signal is received by the monitoring module 120, which utilizes the information therein to identify the event and the changed state of the event. As utilized herein, such a signal is considered a “trigger” from the checklist in that toggling the checkbox triggers transmission of the signal to the monitoring module 120. In this example, the checkbox is binary and toggles between two states, unchecked and checked. In another instance, a checkbox is configured to toggle through more than two states, e.g., to indicate the event has begun, the event is completed, the event is delayed, the event is cancelled, and/or other state, using different graphical and/or textual indicia for each state. Additionally, or alternatively, the electronic form may include other graphical widgets/controls such as dropdown lists, a list box, etc. to toggle between states.

Manual input from users could be requests for more time during a procedure, a request for specific rescheduling, or other input. The monitoring module 120 makes it possible to automatically determine and/or predict that scheduled events will not run on time as scheduled based on automated and/or manual tracking.

By way of non-limiting example, where a subject is scheduled to complete check in by 10:10 AM and checks in by 10:10 AM, the monitoring module 120 receives an input indicating the subject has checked in. In another instance, where the subject has not started check in by 10:10 AM and/or completes check in after 10:10 AM, the monitoring module 120 receives an input indicating the subject has not checked in and/or the subject checked in late. The input can be from a computer, e.g., at the admitting station upon beginning and/or completion of the check in process, manual entry of hospital personnel, a camera observing the subject leaving the admitting station, etc. The monitoring module 120 can be utilized with one or more events of each pathway.

In the example in the preceding paragraphs, the electronic form is a checklist that corresponds to the events in the example pathway 202 illustrated in FIG. 2. Additionally, or alternatively, the monitoring module 120 can monitor workflow based on a clinical guideline tracked in a clinical decision support system, from data in an electronic medical record, and/or local system data that indicates that an event is under way or finishing up via a status indicator of “on track”, “delayed,” etc. By way of non-limiting example, a clinical guideline for a person with acute chest pain may include acquiring an electrocardiogram within a predetermined timeframe from patient arrival at a healthcare entity, etc. Where the monitoring module 120 determines the person is at the healthcare entity and there is no electrocardiograph available in the resource pool 118 within the predetermined timeframe prescribed in the clinical guideline, and/or there is no electrocardiogram in the electronic medical record and/or the local system data within the predetermined timeframe prescribed in the clinical guideline, the monitoring module 120 determines acquisition of the electrocardiogram may be delayed.

The memory 112 further includes a scheduling module 122. The scheduling module 122 schedules the patients in the subject/event list 116 for their corresponding events of interest in the subject/event list 116 based on a relevant pathway model of the at least one pathway model 114 and the resources in the resource pool 118. As described in greater detail below, in one instance this includes scheduling the event of interest of a pathway for a subject and concurrently scheduling all of the other events in the corresponding pathway model 114 for the subject, for all subject to be scheduled for that particular day, mitigating any resource conflicts in a schedule (e.g., not enough staff at a particular time, etc.) arising in connection with one or more of the events across scheduled pathways, and/or rescheduling one or more scheduled events of one or more scheduled pathways to resolve any resource conflicts (e.g., a subject it late, etc.).

The scheduling module 122 can employ the output of the monitoring module 120, which indicates a change to an event, to automatically reschedule events continuously (e.g., every second, every minute, etc.) to update the schedule according to the most recent status of the resources in the resource pool 118. With respect to the above clinical guideline example, the scheduling module 122 automatically updates the schedule based on the next steps to take (or not to take) based on the remaining steps of the clinical guideline in response to the monitoring module 120 detecting an electrocardiogram has been acquired and/or is available in the electronic medical record and/or the local system data. Specifics of the schedule can be automatically communicated to the various stakeholders in a personalized format. For example, a start time for surgery will be differently communicated to the surgeon and to the patient. In general, the schedule will provide an overview of all appointments, which grows, shrinks, and evolves continuously over time.

In one instance, the scheduling module 122 schedules and/or reschedules events in a schedule with or without (automatically) user input. In another instance, the scheduling module 122 further employs a quality score (discussed below) to facilitate such scheduling and/or rescheduling, e.g., by minimizing associated cost. In yet another instance, the scheduling module 122 employs artificial intelligence (discussed below) to facilitate such scheduling and/or rescheduling, e.g., with a trained neural network. In still another instance, the scheduling module 122 employs both the quality score and the artificial intelligence to facilitate such scheduling and/or rescheduling with or without (automatically) user input. In all of these instances, the user can confirm, reject, change, modify, etc. a schedule.

The scheduling module 122 is further configured to generate a scheduler graphical user interface, which is displayed via a display monitor of the output device(s) 108. The scheduler graphical user interface at least presents the resources in the resource pool 118 as a function of time covering a resource time window during which the events of the at least one pathway model 114 can occur, a list of locations for the event of interest as a function of time covering a location time window which is narrower than the resource time window since events can occur prior to and after the event of interest, and the at least one pathway model 114 for the subjects in the subject/events list 116. In one instance, the scheduler graphical user interface also presents the quality score.

The memory 112 further includes a quality score module 124. The quality score module 124 is configured to compute a quality score for a current schedule. This quality score can be based on user preferences, which can be arbitrarily chosen by the end user. In one instance, the quality score is determined based at least on resource conflicts in a schedule. An example of a conflict is where the number of a particular type of resource at a particular time is less than the resource needed at that time. By way of non-limiting example, if there are four intervention events scheduled at the same time in four different cardiac catheterization labs and there are only three doctors available to perform the intervention event, there is conflict in the schedule at least because three doctors cannot be in four different cardiac catheterization labs at the same time. Such conflicts can arise during and/or after scheduling.

In one instance, the quality score module 124 determines the quality score at least based on a predetermined point system preference that includes a cost associated with a day schedule. An example point system assigns a cost of 100 points for a doctor resource conflict, a cost of 20 points for a nurse resource conflict, a cost of 5 points for an admitting clerk resource conflict, etc. With this point system example, and continuing with the above conflict example of four concurrent intervention events with only three doctors available, the quality score would determine a cost of 100. If there were no conflicts, the quality score would be a cost of zero. If there were an additional conflict of requiring two more nurses than available, the quality score would determine a cost of 140 (i.e., 100 + 20 + 20). In another instance, the cost includes the hourly rate of each resource.

Additionally, or alternatively, the quality score module 124 considers personnel preferences. For example, a particular doctor may prefer to work earlier in the day. A point system for this doctor may be zero for a morning assignment, 5 for an afternoon assignment and 10 for an evening assignment. If an objective would be to finish early, the costs of the same resources should increase with the time of the day. In general, the preferences can be user defined and depend on what a particular user thinks is the “best” schedule. For example, if a property of a “good” schedule would require to always have one cardiologist on standby, all moments in time where all available cardiologists would be occupied will be associated with higher costs. If an objective would be to finish early, the costs of the same resources should increase with the time of the day.

Additionally, or alternatively, the quality score can also provide performance related indicators. The indicators can be user defined and depend on what the user considers relevant indicators of performance. Examples of performance related indicators include, but are not limited to, delays in the schedule, an impact of unexpected conflicts, average staff utilization, etc. Additionally, or alternatively, the quality score can be an input (e.g., utilized as a cost function) for an artificial intelligence algorithm, which could be applied to optimize schedules autonomously. Additionally, or alternatively, the quality score can try to create a constant workload for all staff or ‘as constant as possible’, e.g., meaning not too many bumps in the resource histograms. Additionally, or alternatively, the quality score can try to keep one staff member available, if possible in case of emergencies.

Where the scheduling module 122 schedules and/or reschedules events using the quality score, the scheduling module 122 receives and/or retrieves the quality score determined by the quality score module 124 and presents the quality score in the scheduler graphical user interface. In general, the scheduling module 122 schedules and/or reschedules events to minimize cost, e.g., scheduling and/or rescheduling events of pathways to produce a schedule with no (zero) cost based on the cost criteria, produce a schedule with a lowest cost based on the cost criteria, etc. However, a user may select a higher cost schedule amongst schedules with different costs.

The memory 112 further includes a trained artificial intelligence module (AI module) 126 trained with training data. Examples of suitable AI algorithms include, but are not limited to, different types of neural networks, deep neural networks or “deep learning” models, or for example, sequence to sequence models. Throughout this description, the term “neural network” is used to describe a plurality of processing nodes that are densely interconnected. Sometimes, the neural network is organized into layers of nodes, but it is not a requirement. In a layer model, for example, a node may be connected to one or more nodes in a lower layer, from which it receives data, and one or more nodes in a higher layer, to which it sends data. It should also be understood that a neural network is a subset of machine learning, which is a method of data analysis that automates analytical model building. Thus, throughout this description, it should be understood that use of a neural network is only exemplary, and any functions or operations described as being performed by a neural network may be performed by any type of machine learning and should not be interpreted as being limited to only a neural network. Some examples of neural networks include feed-forward neural network, Radial Basis Function (RBF) Neural Network, Multilayer Perceptron, Convolutional Neural Network (i.e. densely connected neural networks, residual neural networks, networks resulting from architecture search algorithms, capsule networks etc.), Recurrent Neural Network(RNN), Modular Neural Network, and any similar types of algorithms which are known in the art or are suitable for the purpose.

The illustrated memory 112 also includes training data 128. In another embodiment, the training data 128 is located remote from the system 102. In either instance, the result of the algorithm (e.g., a schedule) can be included in the training data 128 and used to retrain the AI module 126. In one instance, the training data 128 includes historical scheduling/rescheduling data, which may for example, include or be based upon historical data captured by monitoring module 120 or similar system as described above of the same institution, or historical data provided independently as part of records or database of an independent or third party institution, and rescheduling data which has occurred in view of the aforementioned data. In one example, the AI module 126 is trained with the historical scheduling/rescheduling data to predict an optimal adjustment(s) to a schedule with a prediction model. The scheduling module 120 employs the trained AI module 126 to schedule and/or reschedule events in a schedule.

In another instance, the AI module 126 is trained in two stages. For this instance, the historical scheduling/rescheduling data is transformed to create modified training data. For example, shifts in time are added to the historical scheduling/rescheduling data. By way of nonlimiting example, where historical scheduling/rescheduling data includes shifting an event by the same amount of time as a delay in the previous event, the transformation may create data that shifts the event by an amount less than and/or more than the amount of time of the delay. Other transformations are contemplated herein. With this instance, the AI module 126 is trained in a first stage with the historical scheduling/rescheduling data (historical rescheduling data that successfully resolved resource conflicts and historical scheduling/rescheduling data that required further rescheduling). The AI module 126 is then trained in a second stage with the same training data from the first stage and additionally any modified training data that did not resolve resource conflicts. The scheduling module 120 employs the trained AI module 126 to schedule and/or reschedule events in a schedule.

In another instance, the scheduling module 122 assigns more than one resource to all events, the monitoring module 120 monitors for changes in the one or more resources, and, if the monitoring module 120 detects a change, the scheduling module 122 alerts a user(s) of the change to the event and automatically adjusts the schedule of other events by comparing all of the resources of the changed event to all of the resources of the other events existing on the schedule. For this instance, a repository of historical rescheduling data is trained on a neural network to create a trained data set and the schedule of other events is automatically adjusted based upon the training data set to predict an optimal adjustment with a prediction model by creating a list of optimal resources that are a subset of all of the resources associated with the event to be changed based on the prediction model and comparing all of the resources of the changed event to the subset of all of the resources associated with the event to be changed.

Variations are contemplated. In a variation, the system 102 does not include the quality score module 124. In another variation, the system 102 does not include the trained AI module 126 or the training data 128. In another variation, the system 102 does not include either the quality score module 124 or the trained AI module 126 and the training data 128.

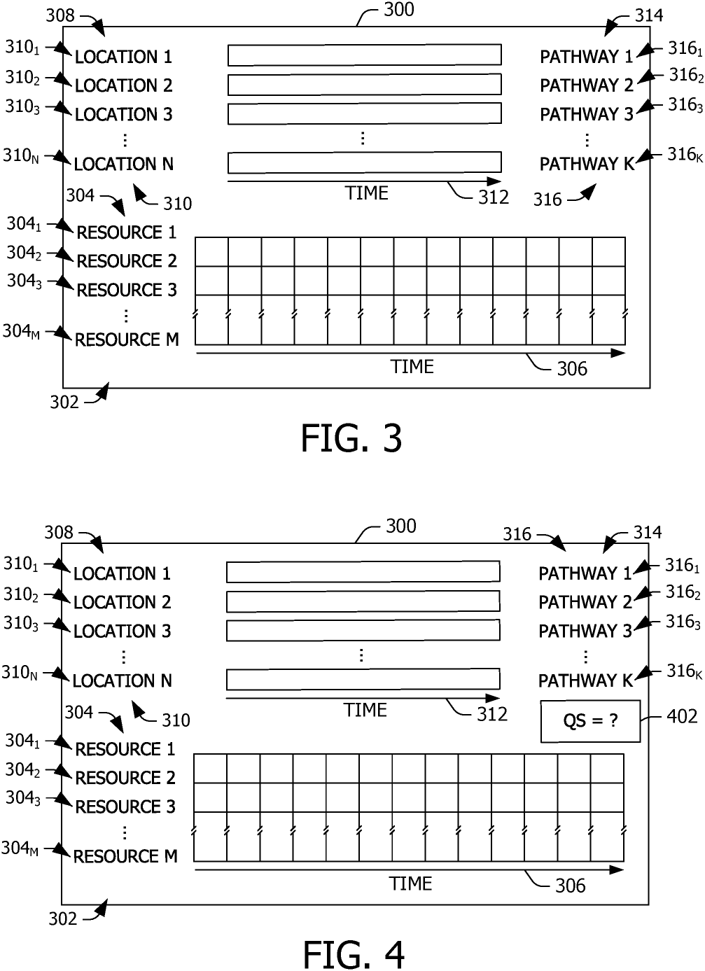

FIG. 3 illustrates a non-limiting example of a scheduler graphical user interface 300. A first section 302 identifies resources 304₁, 304₂, 304₃, ..., 304_{N} (collectively referred to herein as resources 304) of the resource pool 118, where N is a positive integer, available at least during a part of or all of a resource time window 306 (e.g., 7 AM to 9 PM in the illustrated example), a second section 308 identifies locations 310₁, 310₂, 310₃, ..., 310_{M} (collectively referred to herein as locations 310) of the resource pool 118, where M is a positive integer, available for the event of interest and other events occurring at a same location during a location time window 312 (e.g., 8 AM to 6 PM in the illustrated example), and a third section 314 identifies pathways 316₁, 316₂, 316₃, ..., 316_{L} (collectively referred to herein as pathways 316) of the at least one pathway model(s) 114 for scheduling the subjects in the subject/event list 116. FIG. 4 illustrates a variation of the scheduler graphical user interface 300 of FIG. 3 that further presents a quality score 402.

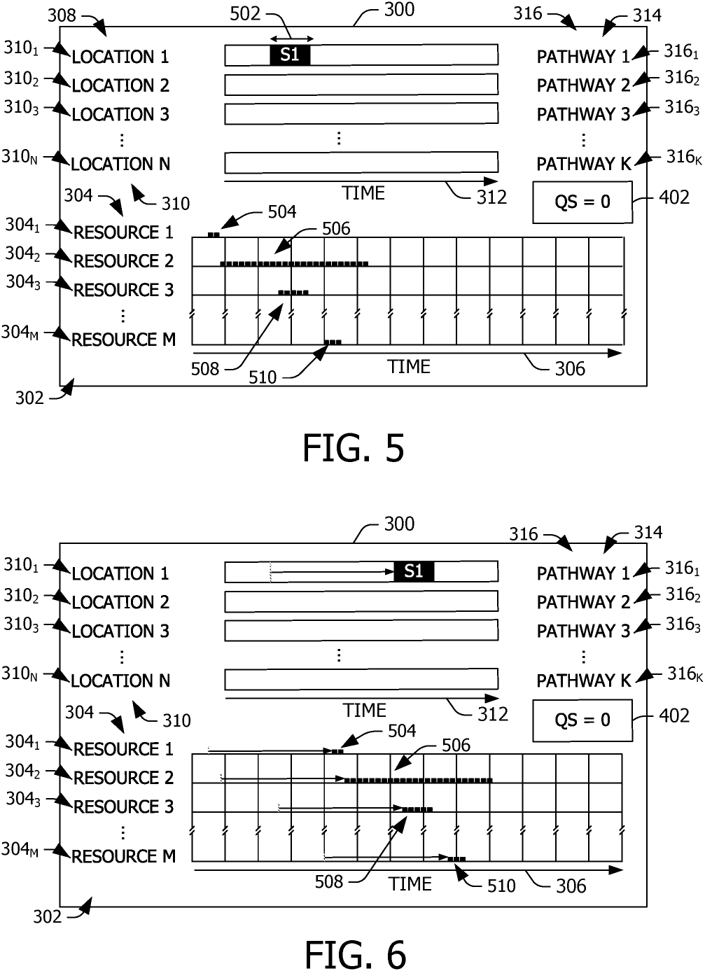

FIG. 5 illustrates an example of the scheduler graphical user interface 300 of FIG. 4 with a pathway S1 scheduled. In this example, the user clicks on one of the pathways 316 and drags and drops the pathway at a position on the location time window 312. Alternatively, the scheduling module 122 can automatically place the pathway S1. A time width 502 of the pathway S1 is equal to a total of the estimated time of each event occurring in location 1 before and after the event of interest and the estimated time of the event of interest. For example, with the pathway 202 of FIG. 2, the time width would equal a summation of the estimated time for the procedure preparation event 214, the cardiac intervention event of interest 204, and the examination room cleaning event 216 since all three of the events require the examination room.

Concurrently with placing the pathway S1 on the location time window 312, the scheduling module 122 schedules the resources 304 of the resource pool 118 for the pathway S1 in the resource time window 306. This includes scheduling resource 1 in a time slot 504, resource 2 in a time slot 506, resource 3 in a time slot 508, and resource 4 in a time slot 510, based on the pathway S1. When moving the pathway 502 within the location time window 312, e.g., by clicking on the pathway S1 and dragging it left or right, the scheduling module 122 simultaneously moves the schedule of the corresponding resources 304 in the resource time window 306. FIG. 6 shows the schedule 300 with the pathway 502 and the resources 304 concurrently moved to a later time slot.

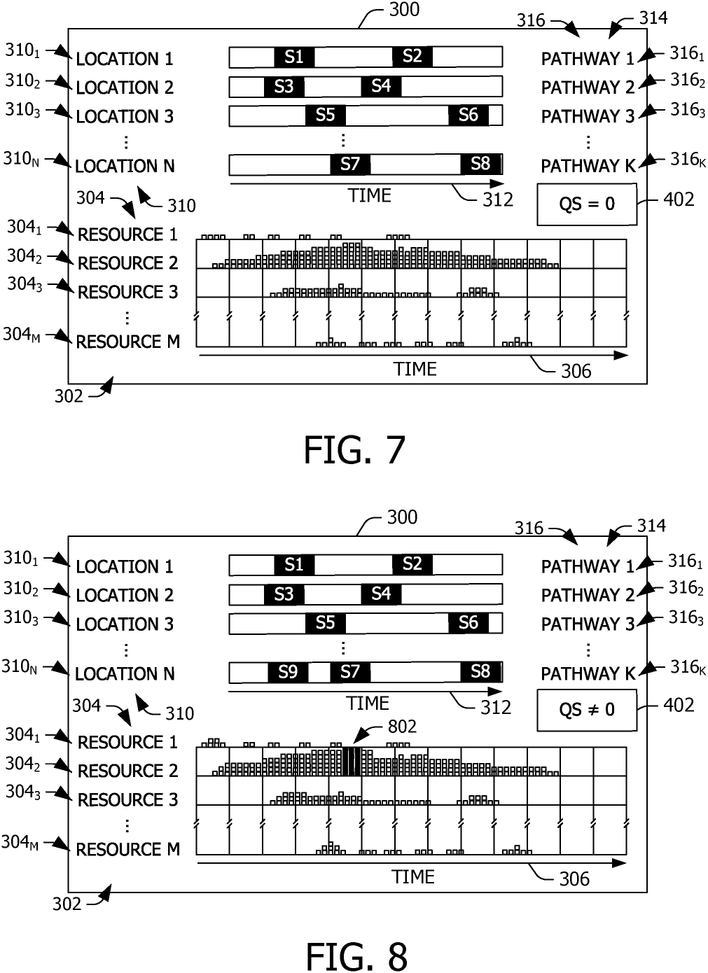

FIG. 7 illustrates an example of the scheduler graphical user interface 300 of FIG. 4 with multiple pathways S1, S2, S3, S4, S5, S6, S7 and S8 for multiple subjects scheduled and no conflicts. In this example, the resource time window 306 includes a resource histogram of the resources scheduled across the pathways 316 and the locations 310. Each time a pathway is added, the resources 304 for the added pathway are populated in the resource time window 306 on top of any existing resources 304 scheduled for already scheduled pathways. The resource histogram provides an overview of the resources required to execute the events for the subjects of the scheduled pathways S1, S2, S3, S4, S5, S6, S7 and S8 over the day.

FIG. 8 illustrates an example of the scheduler graphical user interface 300 of FIG. 7 after the addition of another pathway S9 that results in a resource conflict 802, which is detected by the monitoring module 120. In this example, the resource conflict 702 is with resource 2 and is highlighted with a different color (e.g., black filed squares here) than resources without conflicts (e.g., no fill or white filed squares here). In other embodiments, other highlighting can be employed. In general, the highlighting visually distinguishes resources in conflict relative to resource with no conflict. In this example, the quality score is not equal to zero.

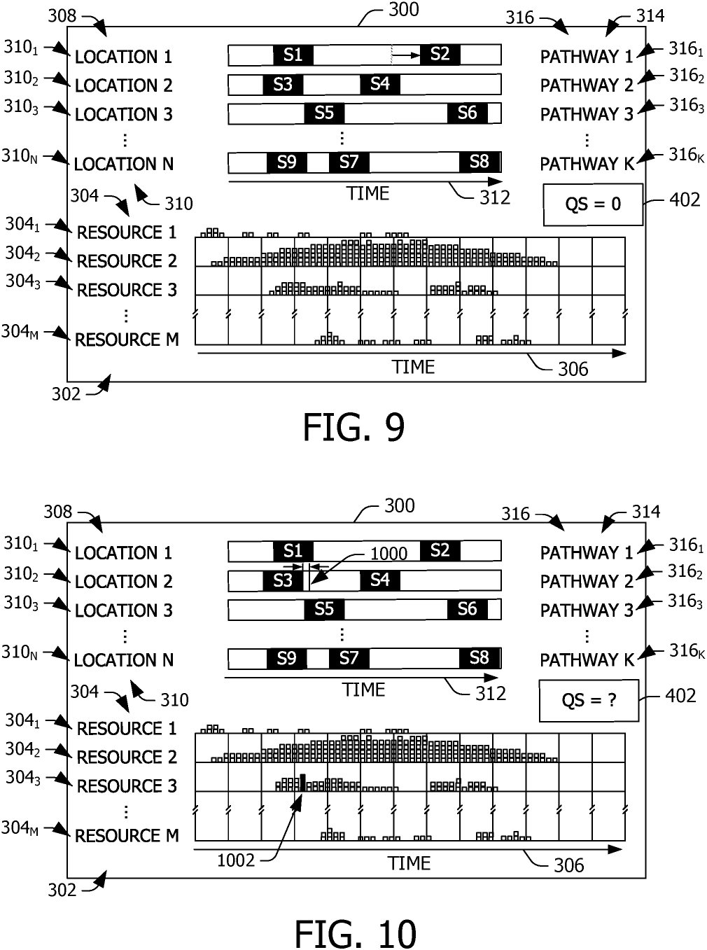

FIG. 9 shows an example of the scheduler graphical user interface 300 of FIG. 8 after automatic rescheduling to resolve the resource conflict 802 in FIG. 8. In this example, the automated rescheduling includes automatically shifting one or more scheduled events of one of more of the scheduled pathways 316 in time back and/or forth until the resource conflict is resolved and/or stopping criteria (e.g., predetermined time period lapses, a predetermined number of shifts have been applied, the quality score no longer decreases, etc.) is reached. In this example, the entire pathway S2 is shifted to begin at a later time to resolve the conflict.

In another embodiment, some, but not all of the events of pathway S2 are shifted to begin at a later time to resolve the conflict. In another embodiment, more than one pathway or a different pathway(s) is shifted to begin at a later time to resolve the conflict. Pathways can be shifted sequentially and/or concurrently in a predetermined order, randomly and/or based on historical data. In another embodiment, the scheduling module 122 recommends removing a pathway from the schedule. In another embodiment, the trained AI module 126 and/or other algorithm, and/or a user input is utilized to resolve the conflict.

FIG. 10 illustrates an example in which one or more events of pathway S3 in the scheduler graphical user interface 300 of FIG. 8 has been delayed by a time 1000, resulting in a resource conflict 1002 with resource 3. As discussed herein, the monitoring module 120 detects such delays. In addition, the scheduling module 122 can send a resource conflict alert to effected parties. In this example, pathways S1 and S9 began before the delay and the delay overlaps with the beginning of pathway S5.

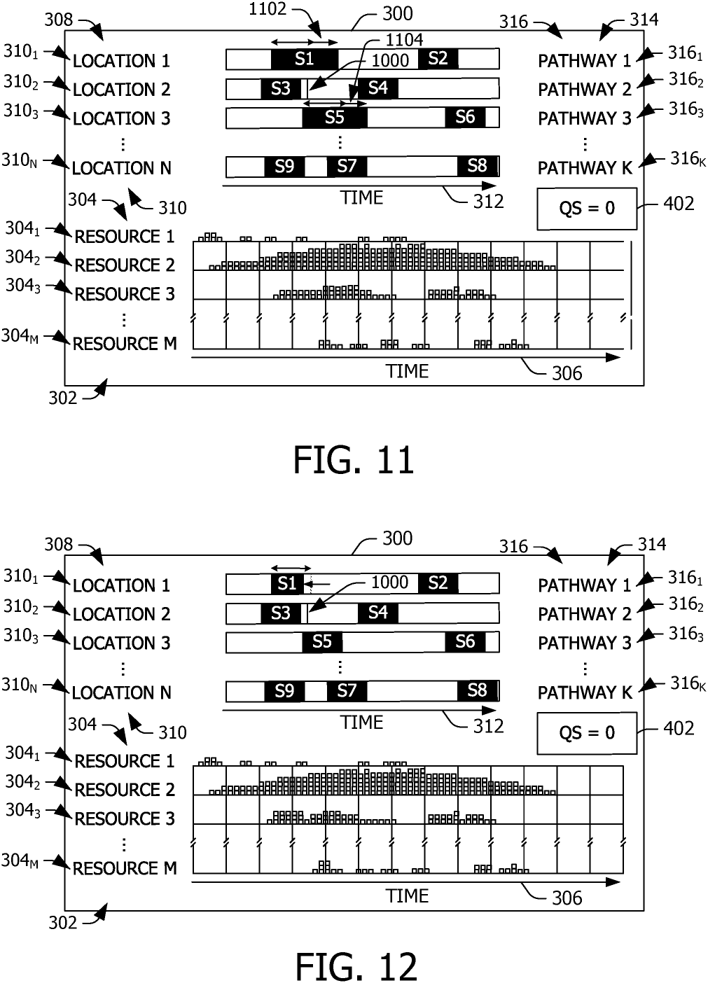

FIG. 11 illustrates an example of the scheduler graphical user interface 300 of FIG. 10 after automated rescheduling to dynamically resolve the resource conflict 1002 while the schedule is being implemented. In FIG. 11, one or more later events of S1 and S5 have been shifted to later times 1102 and 1104 to resolve the resource conflict 1002, extending a total time length of each of the pathways S1 and S5. FIG. 12 illustrates an alternate solution in which early events in the pathway S1 were completed earlier than scheduling, allowing later events in the pathway S1 to move up in time, which resolves the resource conflict 1002 with resource 3. In another embodiment, the trained AI module 126 and/or other algorithm, and/or a user input is utilized to resolve the conflict.

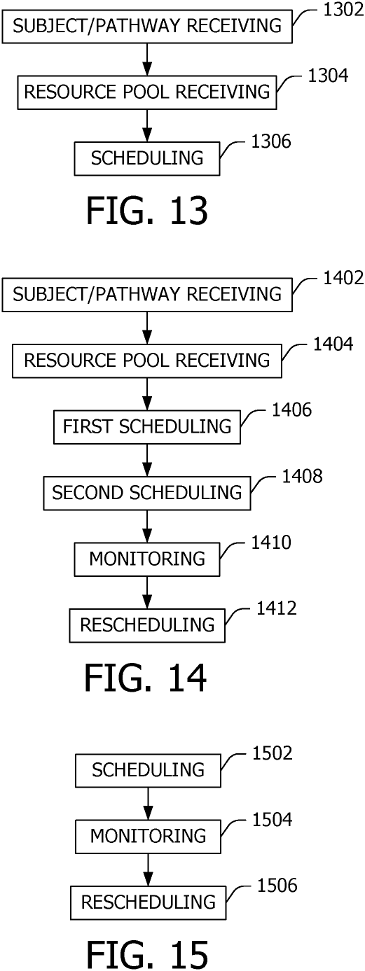

FIGS. 13-17 diagrammatically illustrate example methods in accordance with an embodiment(s) herein. It is to be appreciated that the ordering of the acts of one or more of the methods is not limiting. As such, other orderings are contemplated herein. In addition, one or more acts may be omitted, and/or one or more additional acts may be included.

FIG. 13 diagrammatically illustrates an example method in accordance with an embodiment(s) herein.

A subject/pathway receiving step 1302 receives identification of a set subjects to schedule for pathways on a particular day and identification of a pathway for each of the subjects in the set of subjects, as described herein and/or otherwise.

A resource pool receiving step 1304 receives a schedule of resources scheduled on the particular day for performing the events of the pathways, estimated times to complete each event, and locations for performing the events, as described herein and/or otherwise.

A scheduling step 1306 that creates a schedule, automatically and/or based on a user input, without conflicts for the set of subjects across the locations based on the identified pathways and the schedule of personnel, as described herein and/or otherwise.

In a variation, the scheduling step 1306 creates the schedule further based on a quality score, AI, or both a quality score and AI.

FIG. 14 diagrammatically illustrates an example method in accordance with an embodiment(s) herein.

A subject/pathway receiving step 1402 receives identification of a set subjects to schedule for pathways on a particular day and identification of a pathway for each of the subjects in the set of subjects, as described herein and/or otherwise.

A resource pool receiving step 1404 receives a schedule of resources scheduled on the particular day for performing the events of the pathways, estimated times to complete each event, and locations for performing the events, as described herein and/or otherwise.

A first scheduling step 1406 adds, based on a user input and/or automatically, a first pathway to a schedule, as described herein and/or otherwise.

A second scheduling step 1408 adds, based on a user input and/or automatically, a second pathway to the schedule, as described herein and/or otherwise.

A monitoring step 1410 automatically identifies a scheduling conflict between the pathways, as described herein and/or otherwise.

A rescheduling step 1412 reschedules one or more events of one or more of the pathways by moving, based on a user input and/or automatically, the one or more events to resolve the scheduling conflict, as described herein and/or otherwise.

In a variation, the rescheduling step 1412 reschedules the events further based on a quality score, AI, or both a quality score and AI.

FIG. 15 diagrammatically illustrates an example method in accordance with an embodiment(s) herein.

A scheduling step 1502 creates a schedule, automatically and/or based on a user input, without conflicts for set of subjects across locations based on pathways and resources, as described herein and/or otherwise.

A monitoring step 1504 identifies a delay in a scheduled event which creates a resource conflict amongst scheduled events, as described herein and/or otherwise.

A rescheduling step 1506 reschedules one or more events of one or more of the pathways by moving, based on a user input and/or automatically, the one or more events to a different time slot to resolve the scheduling conflict, as described herein and/or otherwise.

In a variation, the rescheduling step 1506 reschedules the events further based on a quality score, AI, or both a quality score and AI.

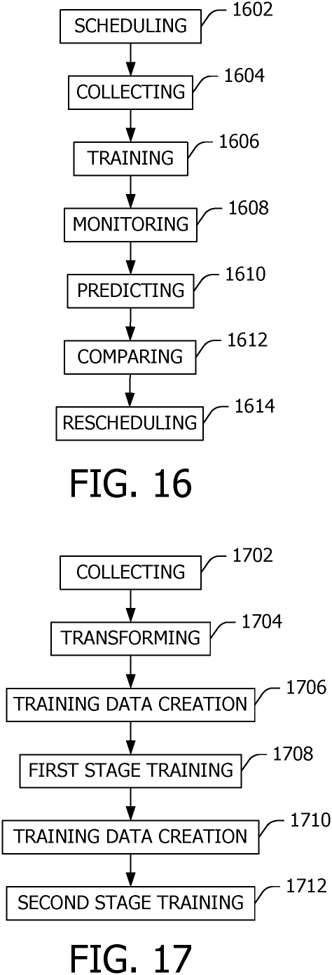

FIG. 16 diagrammatically illustrates an example method in accordance with an embodiment(s) herein.

A scheduling step 1602 schedules multiple pathways in a schedule.

A collecting step 1604 collects historical rescheduling data from a database.

A training step 1606 trains an AI algorithm, e.g., a neural network, with the historical scheduling/rescheduling data to create a trained neural network data set.

A monitoring step 1608 detects a change to an event of a pathway of the scheduled multiple pathways, wherein the change results in a resource conflict in the schedule.

A predicting step 1610 employs the trained neural network to automatically predict an optimal adjustment to schedule with a prediction model.

A comparing step 1612 compares resource assignments in the predicted optimal adjustment with the resource assignment in the schedule.

A rescheduling step 1614 reschedules the multiple pathways based on the predicted optimal adjustment in response to the predicted optimal adjustment resolving the resource conflict.

FIG. 17 diagrammatically illustrates an example method in accordance with an embodiment(s) herein.

A collecting step 1702 collects historical rescheduling data from a database resolving resource conflicts in schedules.

A transformation step 1704 applies a transformation to the first historical rescheduling data to create modified historical rescheduling data.

A training data creation step 1706 creates a first set of training data including the historical scheduling/rescheduling data, the modified historical scheduling/rescheduling data, and a set of historical scheduling/rescheduling data that failed to resolve resource conflicts in schedules.

A first stage of a training step 1708 trains the AI algorithm, e.g., neural network, using the first set of training data.

A training data creation step 1710 creates a second set of training data including the first set of training data and historical scheduling/rescheduling data fails to resolve resource conflicts in schedules after the first stage of training.

A second training stage step 1712 trains the AI algorithm, e.g., neural network, in a second stage with the second set of training data.

The above methods can be implemented by way of computer readable instructions, encoded, or embedded on the computer readable storage medium, which, when executed by a computer processor(s), cause the processor(s) to carry out the described acts or functions. Additionally, or alternatively, at least one of the computer readable instructions is carried out by a signal, carrier wave or other transitory medium, which is not computer readable storage medium.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

The word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for scheduling multiple pathways in a schedule, each pathway including a collection of related events, the method comprising:
training a neural network with a repository of historical rescheduling data to create a trained data set;
assigning resources from a resource pool to each of the events of each of the pathways to create the schedule;
detecting a change in a resource assigned to an event; and
automatically adjusting at least one other event in the schedule in response to the detected change based on the trained data set to predict an optimal adjustment to the schedule with a prediction model.

2. The system of claim 1, wherein automatically adjusting the at least one other event in the schedule is further based on a cost function.

3. The method according to claim 1, further comprising:
collecting first historical rescheduling data;
transforming the collected first historical rescheduling data to create transformed second historical rescheduling data; and
combining the first historical rescheduling data and the transformed second historical rescheduling data to create the repository of historical rescheduling data.

4. The system of claim 1, further comprising:
automatically adjusting the schedule of the at least one other events in the schedule by comparing all of the resources of the changed event to all of the resources of the other events existing on the schedule.

5. The system of claim 1, further comprising:
creating a list of optimal resources that are a subset of all of the resources associated with the at least one other event based on the prediction model; and
comparing all of the resources of the changed event to the subset of all of the resources associated with the event to be changed.

6. The system of claim 1, further comprising:
presenting a graphical user interface with the schedule, wherein scheduling an event of a pathway in the schedule automatically schedules the other events in the collection of related events of the pathway in the schedule.

7. The system of claim 6, wherein moving the event of the pathway in the schedule automatically reschedules the other events in the collection of related events of the pathway in the schedule.

8. The system of claim 6, further comprising:
computing a cost associated with assigning resources to the events; and
scheduling the events to minimize the cost.

9. The system of claim 5, wherein the detected change increases the cost for resources assigned to events; and further comprising:
rescheduling the events to reduce the cost.

10. The system of any of claim 9, wherein the rescheduling includes automatically shifting events forward in time, back in time, or both forward and back in time until the cost is reduced.

11. A system for scheduling multiple pathways in a schedule, each pathway including a collection of related events, the system comprising:
a memory including:
an artificial intelligence module;
a monitoring module;
a scheduling module; and
a processor configured to:
train, with the artificial intelligence module, a neural network with a repository of historical rescheduling data to create a trained data set;
assign, with the scheduling module, resources from a resource pool to each of the events of each of the pathways to create the schedule;
detect, with the monitoring module, a change in a resource assigned to an event; and
automatically adjust, with the scheduling module, at least one other event in the schedule in response to the detected change based on the trained data set to predict an optimal adjustment to the schedule with a prediction model.

12. The system of claim 1, wherein the scheduling module automatically adjusts the at least one other event in the schedule further based on a cost function.

13. The system of claim 11, wherein the processor:
collects first historical rescheduling data;
transforms the collected first historical rescheduling data to create transformed second historical rescheduling data; and
combines the first historical rescheduling data and the transformed second historical rescheduling data to create the repository of historical rescheduling data.

14. The system of claim 11, wherein the processor:
automatically schedules all events of a pathway concurrently;
computes a cost associated with assigning resources to the events; and
schedules other pathways to minimize the cost function.

15. The system of claim 11, wherein the processor:
detects a change to a resource of an event which causes a resource conflict between scheduled events and increases a value the cost function; and
reschedules events to reduce the value of the cost function.

16. A computer-readable storage medium storing computer executable instructions, for scheduling multiple pathways in a schedule where each pathway including a collection of related events, which when executed by a processor of a computer cause the processor to:
train a neural network with a repository of historical rescheduling data to create a trained data set;
assign resources from a resource pool to each of the events of each of the pathways to create the schedule;
detect a change in a resource assigned to an event; and
automatically adjust at least one other event in the schedule in response to the detected change based on trained data set to predict an optimal adjustment to the schedule with a prediction model.

17. The computer-readable storage medium of claim 16, wherein the computer executable instructions further cause the processor to:
automatically adjust the at least one other event in the schedule further based on a cost function.

18. The computer-readable storage medium of claim 16, wherein the computer executable instructions further cause the processor to:
collect first historical rescheduling data;
transform the collected first historical rescheduling data to create transformed second historical rescheduling data; and
combine the first historical rescheduling data and the transformed second historical rescheduling data to create the repository of historical rescheduling data.

19. The computer-readable storage medium of claim 16, wherein the computer executable instructions further cause the processor to:
automatically schedule all events of a pathway concurrently;
compute a cost associated with assigning resources to the events; and
schedule other pathways to minimize the cost function.

20. The computer-readable storage medium of claim 16, wherein the computer executable instructions further cause the processor to:
detect a change to a resource of an event which causes a resource conflict between scheduled events and increases a value the cost function; and
reschedule events to reduce the value of the cost function.
